(19) United States
(12) Patent Application Publication
(10) Pub. No.: US 2008/0071830 A1
(43) Pub. Date: Mar. 20, 2008

(54) METHOD OF INDEXING AND STREAMING MEDIA FILES ON A DISTRIBUTED NETWORK

(76) Inventor: Bray Pike, Anthem, AZ (US)

Correspondence Address: LAW OFFICE OF WAYNE CARROLL, 7830 N. 23RD AVE, PHOENIX, AZ, 85021, US

(21) Appl. No.: 11/532,064

(22) Filed: Sep. 14, 2006

(51) Int. Cl. G06F 7/00

(52) U.S. Cl. 707/104.1

(57) ABSTRACT

The present invention provides a method and system of delivering media content on a network, such as the Internet. Specifically, the present invention includes a database indexing media content available on the network. The database is searchable for selection of a subset of the available media content. The system retrieves the media content from locations identified in the database in a streaming format to be played at a user computer.

### BACKGROUND

1. Technical Field

The invention relates to a method of indexing and delivering files over a distributed network. Specifically, the invention relates to a method of indexing audio, video, and interactive content on the internet, and delivering that content in a streaming format.

2. Background Art

The internet is a rich resource for audio and video content and many different systems are currently used to access the different audio and video files spread across many different web pages, computers, and servers. With current systems, if a user wishes to assemble media content from different websites, each website must be visted and the media content is then downloaded or streamed from each website. If the user wishes to distribute the assembled media content, it has been necessary to either copy the content, or collect weblinks which others must use to visit websites one by one. When content is copied and distributed resources are used for bandwith to transmit the content and for storage space to store the content. Also the artist or owner of the content does not retain control over the content, resulting in instances of poor quality copies or violation of the rights of the artist or owner. To distribute content by including links to websites is ineffective because of the time involved for the person receiving the web links to load each web page and find the specific content desired.

Another challenge in utilizing the media content available on a network is finding the content. Many web crawlers (including spiders bots and such) are employed to index content on networks, and make the content searchable. Web crawlers are usually interested in searching for all content, and are only following links from one web page to the next. The process of indexing all content is a large task and takes a large amount of time and resources. In many cases a web page is available, but the content is not indexed, due to the time required to index all content.

As the internet or a network is constantly changing, the links from one website to another may change and a webpage or location with valuable content may not be indexed due to the fact that there is not a valid link to the page. This may be due to the linking page being changed, or the linking page not having the correct URL or other pointer to the location. The page or location may not be indexed due to the time required for a crawler to find and index the page. When a page still exists, but it is not indexed it is in the “dark” and is often not utilized. This “dark internet” is not utilized because the major point of access is through the web crawlers which index pages.

Artists and owners of new content have the challenge of distributing content to a wide audience. Traditional methods of distribution have been radio and television which are prohibitively expensive for most artists. Content may be distributed by giving copies away, but if this is done digitally it is very easy for the content to be further distributed without control by, or payment to the artist.

In view of the forgoing, there exists a need for a method and system for searching and indexing specific content on a network such as media files, including content which is not linked to by other pages. A need also exists for a method of distributing and delivering specific collections of content in a manner which is simple to receive and use and which respects the copyrights of the content owner.

### SUMMARY

In an embodiment of the invention an indexing and delivery system includes an automated indexing program which searches for media files, including, but not limited to audio, video and interactive files, which are freely available on the internet. The automated indexing program may include a web crawler or spider, which follows links on websites to find pages with desired content. When the desired content is found, the path or location of the content is indexed in a database with the title of the file as well as text descriptions associated with the file. Another method of searching and indexing files in a database involves an automated indexing program which generates random URL addresses in order to find a starting page for searching and indexing media files in a network. By using random starting URLs media content which may not be found by other web crawling processes may be found.

An embodiment of the invention also includes a computer program which communicates with a database. A user may use the computer program to conduct a search of the database for desired content. When desired content is found and selected, the computer program uses the path or location from the database to access the desired content. The desired content is then transferred to the computer program, which converts the content into a streaming format to be seen or heard by the user. If the content is already in a streaming format, then no conversion is needed, and the computer program may display the content. The streaming format does not allow a user to save the content which is being streamed, and allows the owner to control copying of the content.

In another embodiment of the invention the computer program may be connected to and accessed over the internet and the database accessed by the computer program over the internet. Many different users may obtain a copy of the computer program and access the same database.

An artist or owner of new media content may distribute access to the content by using an embodiment of the present invention, without distributing, and losing control of the content. When content is made available on the internet it may be indexed in the database, but users may not know about the content or find it when searching the database because it is new and they may not be looking for it. The artist or owner may produce a modified computer program which acts as a media player, and searches the database. The program would be modified so that each time it is first opened the names of the artist's new songs may be displayed before a search is performed. The names of the songs maybe linked to the database which has indexed the content. The modified computer program may be distributed to people interested in the artist's work, who may further freely distribute the computer program to others. In this way an artist may distribute access to their work and display their work without the work being copied. Unlike a system of distribution where the new content is copied in distribution, the owner may display the work for a limited time using the modified computer program.

### BRIEF DESCRIPTION OF THE DRAWINGS

FIG. 1 depicts a network of computers.

FIG. 2 is a flow diagram of a process for indexing media files.

FIG. 3 is a flow diagram of a process for delivering content on a network.

FIG. 4 is a flow chart of a process for distributing a media player with access to content on a network.

### DETAILED DESCRIPTION

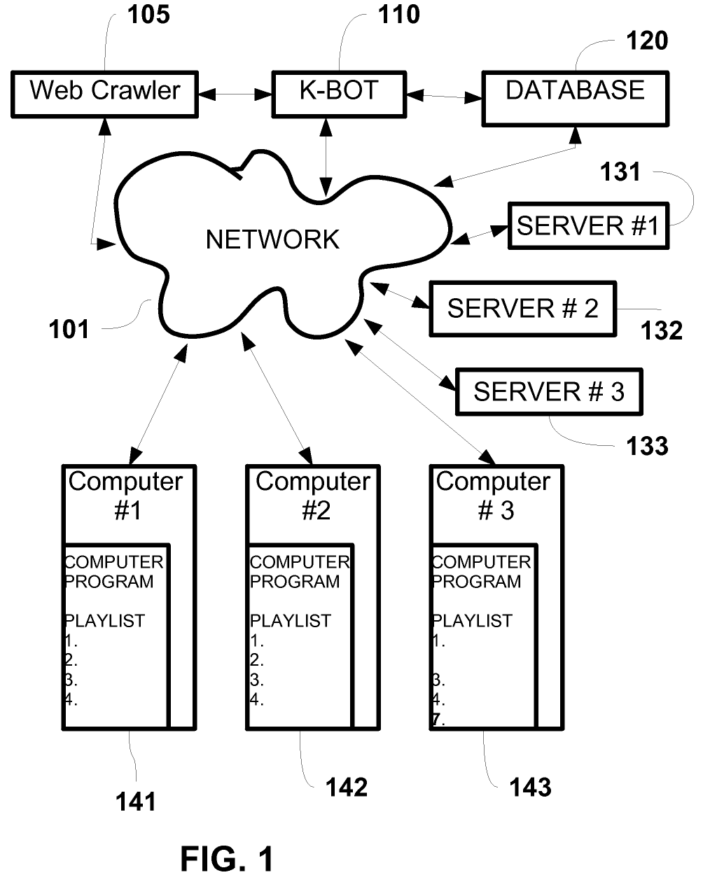

A system according to an embodiment of the present invention may be used to deliver media content on a network, including audio, visual, and interactive content such as games. The system includes a database 120 maintaining information relating to the available media content. The content may be stored in any computer connected to the network 101. The system further allows users on the network to share and transfer information relating to the available media content. FIG. 1 illustrates typical components of a network with which the system of the present invention can be used. The present system may search for content and index content from the servers 131, 132, and 133 with a first computer program, which may be a Web Crawler 105 and a K-Bot 110. The index of content may be searched by a user on a web page, and the content delivered to the user in a streaming format. A user, using computer #1 may also load a second computer program which may act as a media player, (a computer program which displays images and sound from digital files) and may allow searching of the database 120. The database 120 and the second computer program may be designed to work together exclusively so that the database is only accessed by a computer running the second program, and the second program only accesses the database, and not other databases. The second computer program may also convert the content to streaming format. When a file is delivered in streaming format it is not saved to the local computer except in temporary format. The streaming format displays the audio or video but does not display the location of the file.

As an artist or owner of content may use this system to broadcast content without it being copied, it may be desirable to have a secured connection between the second computer program and the database. A link to the content on the internet, as indexed in the database may also be a secured connection so that the content may be delivered to those who are using the second program. In this way the content would be available for streaming but not available to public access for copying.

FIG. 1 depicts a network of computers. The computers communicate through a network 101. The network includes: a Web Crawler 105, which may also be a spider, or other automated process of searching content on a network; a K-Bot 110, or automated computer process which searches for content on a web server which does not have known links pointing to the content; a database 120, which may include an indexing of file locations and content from the Web Crawler 105 and the K-Bot 110; servers 131, 132, and 133, which may be web servers containing content for web pages; and computers 141, 142, and 143, which may be personal computers.

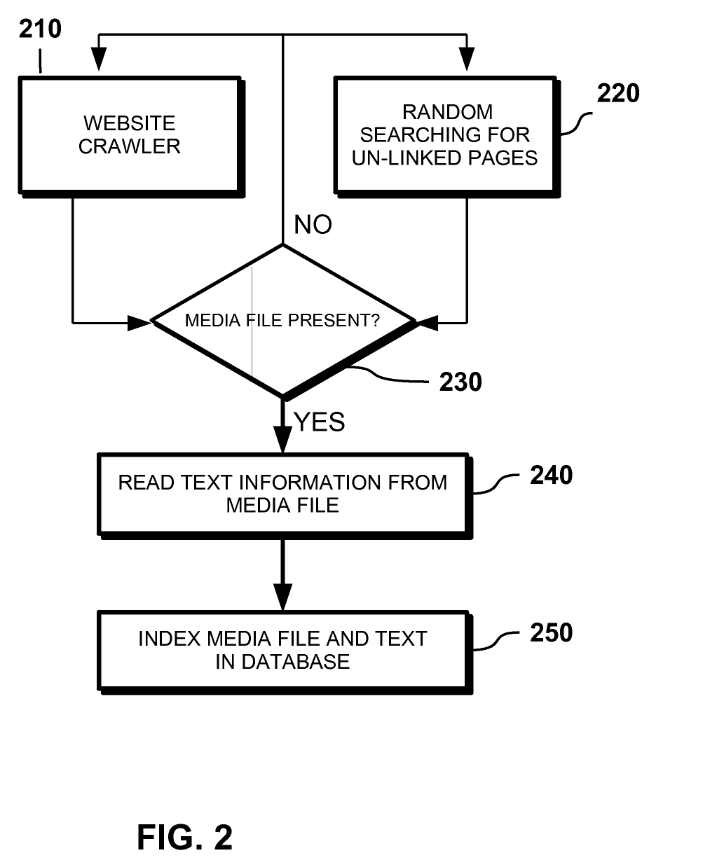

The process of searching and indexing content on a network is shown in FIG. 2. The content may be indexed using a web crawler 210, which follows links from one web page to the next web page searching for content not yet indexed, or content may be indexed using a process of random searching for un-linked pages 220. The process of random searching may allow locations on the network which contain desired files to be located even though a spider or web crawler would not locate the files.

In an embodiment of the system the searching involves searching for media files, and only indexing media files. The web crawler 210 and the random searching process 220 may continue searching until a media file is found, as show by the decision process 230, and then the text information from the media file will be read 240, and indexed in a database 250. In the embodiment of the system it is not necessary to copy the media file, but the location and text information from the media file is indexed. The text information may include information such as the title and author of a song, the title of the album, the name of the performers, the date of performance and other information relating to a song. The text information may be the type found in an ID3 tag. The text information may also include copyright information or other ownership information. Non-text information such as an image for the cover of an album may also be indexed.

The database 120 may be categorized by types of files. This may allow a search to be executed faster. When a user wishes to search for a file the user may first select the category of file, and then enter the search query. Only the links which are indexed as links to that type of files will be searched, and this may allow a faster result, as only a portion of the database is searched, and not the whole database. The types of categories may include, but are not limited to: audio files, video files, flash media files.

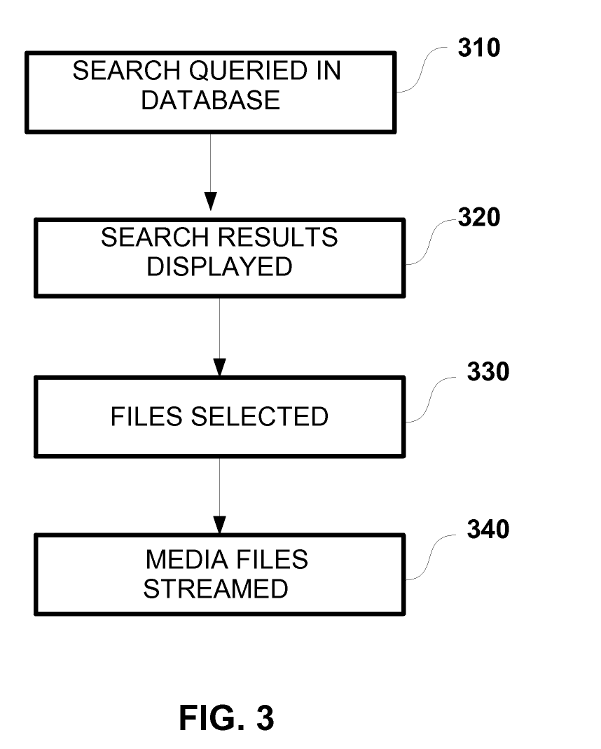

As shown in flow chart format in FIG. 3 the user may query the database for specific desired content on the network 310. The query is sent to the database and the results of the query are sent back and may contain file names and other information about the content. The search results are then displayed to the user 320. The file is not stored in the database, but the filename and location of the file are stored in the database. From the search results the user may select a filename 330. As the database stores the link to the file which is located on one of the servers, the system may retrieve the link and begin downloading the file from the linked location. The system then locates the file which is delivered to the user in a streaming format 340. When the user, using computer #1, 141 searches the database using the media player, they may select files which are indexed in the database to stream. Multiple files may be selected creating a list of files which may be streamed one after the other. The files or content delivered in a streaming format may be delivered in a way that prevents copying of the content, but allows for the content to be heard.

In the present embodiment discussed, files may be indexed which are available through the internet. This will allow the owner of a website to have control over the content of the website. Unlike a distribution system where copies of music or video files are copied in distributing content, the present system allows the owner of content to display content and allows web users to view and hear the content, but not copy, the content.

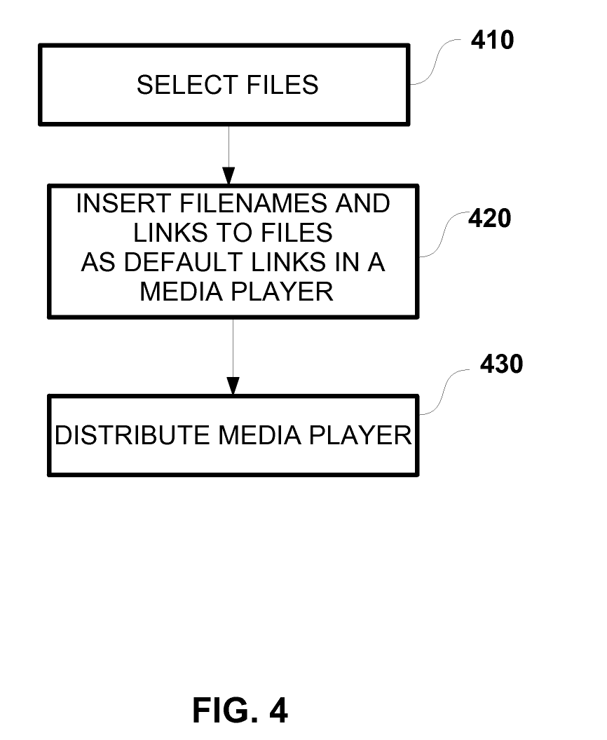

FIG. 4 shows a flow chart of a process for distributing a media player with access to content on a network. An owner of content may have new content to display and may use the database to select and assemble a group of links to the database, representing selected files which are indexed in the database (shown as 410). The links to the selected files may be displayed as filenames. The filenames with links to the database may be inserted into a program which can connect with the database (shown as 420). The connection between the program and the database may be a secured connection. The program may also be part of a media player. To distribute the new content, the owner may allow for copying of the program and media player which has been modified with the specific content of the owner (shown as 430). When the program and media player as modified by the content owner is opened on a computer, and can communicate with the database, the filenames of the new content may be displayed as links. When the program and media player are used to access the new content, then the content is streamed to the computer of a user and displayed without a permanent copy on the computer. The program and media player may be copied and distributed without the new content being distributed.

When distributing links to content, the links may be distributed without the media player, if the users receiving the links already have a media player according to the present embodiment of the invention. In the present embodiment of the invention a secure connection is used between the database and the media player. The media player distributed contains the authentication for the secure connection, and with out it the links will not work, as the links are links to the database, and not the content itself. If a user does not already have a copy of the media player program it is advantageous to distribute the media player and the list of files together to ensure access to the database, and the content.

For example if a band produces several songs and wants their fans to have access to listen to the songs for the first thirty days, the band could place the songs on a website accessible and indexed by a database according to the present invention. A media player with a program according to the present invention could be produced with the song names and links to the songs in the media player. The media player with the program and list of songs may be distributed as a download from a website, as an attachment to an e-mail, as a file on storage medium or any other method of distributing files. When a loyal fan receives the media player with the list of song names the fan may install the program and may select a song name from a list. The media player will begin streaming the new song to the computer of the loyal fan. The website with the songs may have a secure connection so that authentication is required to access the website. When the program is loaded it may contact the database for the necessary information to authenticate and access the secured site with the bands songs. After the first thirty days the band may change the content at the location to only play a sample of the song. The loyal fan with the program installed may use the program to search for other content available on the internet, and indexed in the database.

In other embodiments of the invention the media player may connect with the database using an unsecured connection, and the links on the media player may be direct links to the content instead of links to the database. The database may also include an interface where users may indicate a link does not work. The searching program may attempt to verify the location of content, and if changes are necessary update the database.

In an embodiment of the invention, a user may select media files which are indexed in the database 410 such as songs and video clips, to create a list of files which may be played one after the other. The list of files may be saved locally with the media player 420. The media player with the list of files may be distributed to other users 430 so that the users may share information about content available on the internet. When a media player is received with content from another user, it may be customized with links to content added or removed from the media player. This is shown in FIG. 1 where the user of computer #1 has assembled links to content in the in the computer program, showing links to songs 1, 2, 3, and 4. The computer program with the links to the content is sent to the users of computer #2 and computer #3. The user of computer #2 chooses to add all the links to a playlist stored locally, but the user of computer #3 chooses to only add some of the links to a locally stored play list, excluding song 4, and adding an additional link, song 7. The individual play lists may also be stored on another computer connected to the network.

While the principles of the invention have been made clear in illustrative embodiments, there will be immediately obvious to those skilled in the art many modifications of structure, arrangement, proportions, and methods, the elements, materials, and components used in the practice of the invention, and otherwise, which are particularly adapted to specific environments and operative requirements without departing from those principles. The appended claims are intended to cover and embrace any and all such modifications, within the limits only of the true spirit and scope of the invention.

What is claimed is:

1. A system of indexing and distributing media content on a network for use on a computer, the system comprising:
a database connected to the network, the database including information identifying a plurality of media files and corresponding locations of the media files on the network;
a first computer program which communicates with and searches the database, retrieves links to media files, and delivers the media files to the computer with the second computer program, the media files being delivered in a streaming format, the media files being displayed through audio and video devices controlled by the computer with the second computer program;
a communication link between the first computer program and the database.

2. A system of indexing and distributing content on a network for use on a computer according to claim 1 further comprising a second computer program which performs automated searching and indexing of media files in the network, storing and indexing the search results in the database.

3. A system of indexing and distributing content on a network for use on a computer according to claim 1 where the network of computers includes web servers connected to the internet.

4. A system of indexing and distributing content on a network for use on a computer according to claim 3 where the content includes files on web pages and stored on the web servers.

5. A system of indexing and distributing content on a network for use on a computer according to claim 1 where the first computer program delivers a first media file from a first location on the network of computers in streaming format, followed by automatic delivery of a second media file from a second location on the network in streaming format.

6. A system of indexing and distributing media content on a network for use on a computer according to claim 1 further comprising means for storing information so that a list of content from different locations on the network may be stored.

7. A system of indexing and distributing content on a network for use on a computer according to claim 1 where the searchable database is categorized by type of file.

8. A system of indexing and distributing media content on a network for use on a computer according to claim 1 where the communication link is a secured network connection.

9. A method of delivering media content on a network comprising the steps of:
automatically searching the network for media content using a computer automated process;
indexing the location and filename of the media content in a database;
searching the database for specific media content;
converting the specific media content to a stream format; and
delivering the specific content in streaming format.

10. A method of delivering content on a network according to claim 9 where the media content includes formats for audio, visual, and interactive formats.

11. A method of delivering content on a network according to claim 9 where the network comprises web servers.

12. A method of delivering content on a network according to claim 9 where the indexing includes storing text information from the media content on the network.
